(19) United States
(12) Patent Application Publication
(10) Pub. No.: US 2009/0248670 A1
(43) Pub. Date: Oct. 1, 2009

(54) Content search engine

(76) Inventor: Trevor Fiatal, Fremont, CA (US)

Correspondence Address: CARR & FERRELL LLP, 2200 GENG ROAD, PALO ALTO, CA, 94303, US

(21) Appl. No.: 12/080,142

(22) Filed: Mar. 31, 2008

(51) Int. Cl. G06F 7/06; G06F 17/30

(52) U.S. Cl. 707/5; 707/E17.017

(57) ABSTRACT

Search constraint specific searching for content from a mobile device is disclosed. Following a mobile device generated request for content, a content server provides for the search of content on a network service or personal computer. The search for content may occur directly through the content server or via a connector application. An index engine parses and lists structured and unstructured content, which may be responsive to the search request. The content server or a proxy then provides a sub-set of the search results, that subset corresponding to both the mobile device generated request for content and a search constraint such as mobile device capabilities or network service provider limitations.

### CROSS-REFERENCE TO RELATED APPLICATIONS

The present application is related to U.S. patent application Ser. No. 12/002,300 filed Dec. 13, 2007 and entitled “Content Delivery to a Mobile Device from a Content Service.” The present application is also related to U.S. patent application Ser. No. 12/011,396 filed Jan. 25, 2008 and entitled “Policy Based Content Service.” These related applications are incorporated herein by reference.

### BACKGROUND

1. Field of the Invention

The present invention generally relates to the field of wireless mobile device network services. More specifically, the present invention relates to searching for content stored at a remote location via a mobile device in accordance with one or more search constraints.

2. Description of Related Art

The Internet allows users to access remotely stored data through a computer. Traditionally, the computer was a desktop or laptop computing device. Modern day mobile devices such as Smart Phones and Personal Digital Assistants (PDAs) now have computing power and network capabilities that are nearly equivalent to those of a desktop or laptop computer. As such, mobile devices may now remotely access data in a manner similar to that of a desktop or laptop computer. For example, digital content such as audio or video may be retrieved over a communications network for playback on a mobile device.

Notwithstanding these advances in mobile device technology, the spectrum of available content often exceeds the limits of what can be accessed or executed by any particular mobile device. Each mobile device will, for example, have varying capabilities such as resident software applications (e.g., codecs), screen size and resolution, memory capacity, and processing power. Similarly, a network service provider policy may limit the content accessible at any given time by controlling bandwidth usage or restricting the total amount of data that may be transferred for a set period of time. Network service providers may also implement policies blocking access to certain addresses or domains (e.g., those of content providers engaged in illegal sharing of copyrighted content).

For example, a user may try to access content from their mobile device only to get an error message indicating that the content is unavailable. The error message may not necessarily indicate why the content is inaccessible. This lack of information may prevent the user from effectively selecting content in the future as the user may continue to attempt to select content that is inaccessible on the user's particular mobile device.

By further example, a list of content available at a particular content source may not display the associated content format (e.g., AAC, MP3, WMV). As a result, the user will not be able to select the appropriate format-specific content for their mobile device. This user would encounter this problem even if the error messages indicated why previous content selections could not be accessed (i.e., unavailable codec).

### SUMMARY

Limiting the identification of available content to only that content that can be accessed by the mobile device (e.g., content that complies with mobile device capabilities and/or a network service provider policy) allows for more efficient access to content over a network. Increased efficiencies also result with respect to preservation of mobile device and network resources (e.g., battery power and network bandwidth) in that a user is not unnecessarily attempting to access inaccessible content. The desirability of certain content providers as a preferred provider may result to the extent that those providers offer a more user-friendly experience by identifying only that content accessible to a particular mobile device or over a particular service provider network.

A system for searching content includes a mobile device, a content source, and a content server. The mobile device makes a search request. The content source includes a database of content. The content server receives search requests from the mobile device. The content server sends the requests to the content source. The result of the search request corresponds to a search constraint.

A method for searching for content from a mobile device includes initiating a search request for content from a mobile device, processing the request from the mobile device at a content server, initiating a request from the content server to the content source to search for the requested content, processing the search request from the content server, providing the search results from the content to the content server, processing the search results to correspond to a search constraint, providing the search results that correspond to a search constraint from the content server to the mobile device. Execution of a computer readable storage medium including a program by a processor may effectuate this method.

### BRIEF DESCRIPTION OF THE DRAWINGS

FIG. 1 depicts an exemplary system where content search requests are initiated by a mobile device.

FIG. 2 depicts an exemplary method for performing content searches initiated by a mobile device.

### DETAILED DESCRIPTION

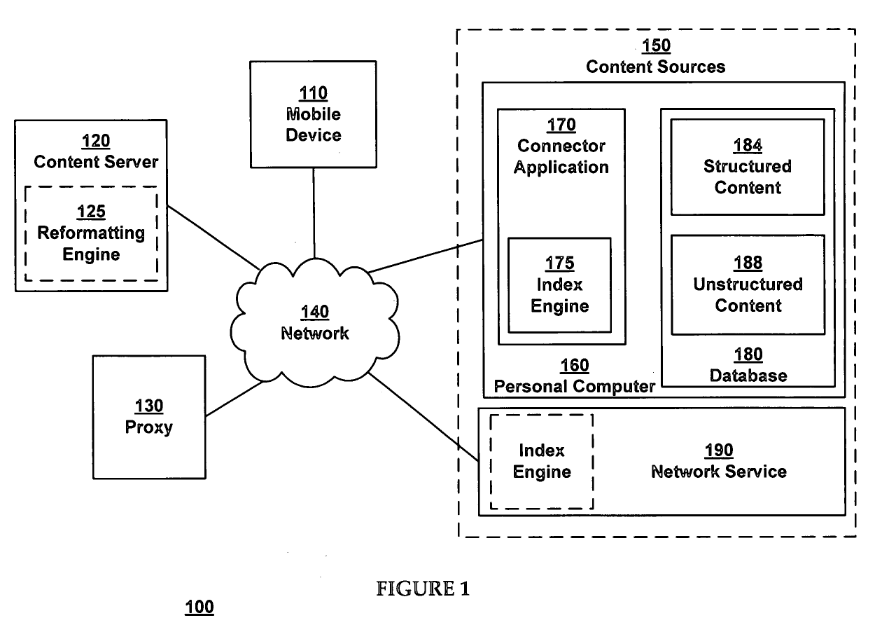

FIG. 1 depicts an exemplary system 100 where content search requests are initiated by a mobile device. System 100 of FIG. 1 includes mobile device 110, a content server 120, network 140, and content sources 150. Additional components may be introduced to system 100 such as billing application servers or third-party application servers.

Mobile device 110 is inclusive of any portable device used for communications or for running a software application such as a PDA, cellular phone, or Smart Phone. Mobile device 110 includes network connectivity such that it may exchange information with other computing devices over network 140. Mobile device 110 may include any number of customized applications (e.g., to interact with network service 190) or general purpose browsers that may allow for or facilitate data exchanges. For example, mobile device 110 may include a ‘search’ application to allow a user to search for content available at one or more content sources 150. Mobile device 110 may include an application allowing for integration and interactivity with connector application 170 at personal computer 160.

Content server 120 is a computing device on the network 140 capable of processing search requests generated by the mobile device 110. Content server 120 may be further capable of initiating searches of content sources 150 for content and that correspond to a search request generated by mobile device 110. For example, content server 120 may translate a search request in a format native to mobile device 110 into a format that may be comprehensible to content sources 150. Content server 120 may be further configured to identify a sub-set of data from search results generated in response to the search request and that correspond to a search constraint related to a mobile device, network service provider policy, or user setting.

The content server 120 may be still further configured to receive requests for content in response to the identified sub-set of data, to retrieve content corresponding to those requests, and to temporarily host that content before delivering the same to the requesting mobile device 110. The content server 120 may cooperate with proxy computing device 130. The aforementioned functionalities may be embodied in a software module or engine executable at the server. Content server 120 may further include applications to allow for interaction with connector application 170 and/or network service 190.

Content server may be operated by a network service provider (e.g., the owner or operator of the network 140). Content server 120 may be associated with a provider of content (e.g., network service 190). Content server 120 may store information concerning search constraints as identified by a network service provider or that correspond to a user profile and a particular mobile device 110 associated with that profile. The profile may be stored at the server 120 or provided in the context of search requests from mobile device 110. Content server 120 may allow for implementation and retention of certain user settings or constraints.

The content server 120 may include an optional reformatting engine 125 configured to reformat content received from content sources 150. The reformatting engine 125 may decode, encode, transcode, and/or resample content downloaded or streamed from content sources 150. The reformatting engine 125 may initiate reformatting of content in order to bring the content within the limitations of a search constraint. For example, a search request may identify the availability of certain content but the content may not comply with a search constraint such as bandwidth allocation. The content may be capable of being reformatted such that it no longer exceeds the search constraint (i.e., excessive bandwidth consumption). Reformatting may thus occur automatically upon identification of and a subsequent request for certain content. Reformatting may also occur in response to a command issued by the user of the mobile device 110 to reformat the content to allow for its delivery to mobile device 110. The reformatting engine 125 may include creating a backup file until content reformatting is complete.

The reformatting engine 125 may reformat an MPEG-2 encoded video file to a 3GP encoded video file by copying the MPEG-2 encoded video file and saving the copied video file as a 3GP encoded video file following transcodings of the same. In a further example, the reformatting engine 125 may reformat an AVI encoded video file having a resolution of 720 by 480 pixels to an AVI encoded video file having a resolution of 360 by 240 pixels. In a third example, the reformatting engine 125 may reformat an MPEG-4 encoded video file having a frame rate of approximately 30 frames per second (fps) to an MPEG-4 encoded video file having a frame rate of approximately 15 fps. The reformatting engine 125, in a still further example, may reformat an MP3 encoded audio file having a bit rate of 192 kilobits per second (kbps) to an MP3 encoded audio file having a bit rate of 128 kbps.

Content reformatting may be a factor dependent conversion related to the network service provider constraint or the capabilities of mobile device 110. Examples of such factors are available storage space, a user-selectable preference, supported codecs, bit rates, sampling rates, sample resolutions, or video frame rates. Other factors warranting conversion also include memory size, free available memory, screen size, and a screen resolution of the mobile device 110.

Proxy computing device 130 is a computing device on the network 140 and in communication with content server 120. Proxy 130 that may be used for load balancing, facilitating premium service offerings (e.g., high speed and prioritized preferred searches), localization of search requests (e.g. geographically), or for dedicated search requests (e.g., from particular network services 190). The proxy computing device 130 may also perform parsing of search results from a content source 150 to generate a sub-set of results that correspond to both the mobile device generated search request and a search constraint similar to that of content server 120. Proxy computing device 130 may be configured to perform any and all functions of the content server 120 and may, in some embodiments, operate as a redundant, fail-over server for content server 120.

Network 140 is inclusive of any variety of communications networks including geographically dispersed telecommunications networks such as a Wide Area Network (WAN) or the Internet, intermediate networks restricted to a metropolitan area such as a Metropolitan Area Network (MAN), and interconnected workstations within a relatively small geographic area such as a Local Area Network (LAN). Network 140 may be homogeneous or heterogeneous with respect to any particular communications medium (e.g., wireless or landline) and may overlap with or be shared by various service providers. Various hardware components (e.g., base stations, routers, and so forth) may be implemented in network 140.

Content sources 150 are any computing device, database, or service accessible via network 140 and hosting content, which is inclusive of audio, video, and audio and video. Content sources 150 may also host other content such as word processing documents, spread sheets, and presentations. Examples of content sources include a personal computer 160 or a network service 190. The system 100 may include several content sources 150 available for content searches.

Search requests may be initiated by the mobile device 110. Search requests may identify desired content such as artists, titles, genres, or series. Search requests generated by the user of mobile device 110 may generally correspond to search requests as may be input to any commercial search engine as is known in the art. The search request generated by the mobile device 110 is then sent to the content server 120 or its proxy 130. The content server 120 (or its proxy 130) then sends its own search request to content sources 150 and which correspond to the mobile device 110 generated requests (i.e., the search parameters are the same). The content sources 150 then return a result identifying available content that is responsive to the request (e.g., content from a particular artist).

Content server 120 (or its proxy 130) then identifies from the returned search results those content selections that correspond to a search constraint related to the mobile device 110 or a network service policy. From the returned search results, the content server 120 (or its proxy 130) will generate a sub-set of data that reflects the available content corresponding to the mobile device generated search request and that also that complies with the aforementioned search constraint. The sub-set of data is then provided to the mobile device 110 to allow for selection and delivery of a particular selection of content.

Through the present system, a user is only provided with a list of content that is available from content sources 150 but that is also capable of being played back or accessed on the mobile device 110 (or communicated over network 140). This filtering functionality prevents a user from attempting to access content that cannot be played back or otherwise provided to the mobile device 110 due to one or more constraints that correlate to the search constraint (e.g., attempting to play a RealAudio file on a Windows Media enabled device).

Search constraints may be stored in a library or data file of constraints (not shown) at the content server 120 or some other computing device accessible by the content server 120 including proxy 130. Constraints may exist with respect to all users of a particular network (e.g., a universal constraint) or users and their particular mobile device or data plans (e.g., user specific constraints). This information may be maintained in a user profile. Users may also implement certain limitations on content delivery such as prohibitions against receiving explicit or pornographic content. Reformatting engine 125 may reformat that content identified in a query of the content sources 150 but that is otherwise in violation of the search constraint. If reformatting is possible, then that content may also be identified in a result returned to the mobile device 110 by the content server 120.

Personal computer 160 is a general purpose computing device as is known in the art. Personal computer 160 may be configured with a connector application 170 that, when executed by personal computer 160, allows for interaction with content server 120 and/or mobile device 110. The connector application 170, in addition to allowing for interaction with content server 120, may execute search requests generated by the content server 120 (and that otherwise correspond to a search request generated by mobile device 110) in order to search for content in a database 180 of content available to the personal computer 160. In some embodiments, the connector application 170 may interact with network service 190 to effectuate similar searches. Content available in database 180 may include both structured content 184 and unstructured content 188.

Structured content 184 is that content having defined or ordered characteristics as identified by the user. Such identification may occur through indexed file folders or some other organized hierarchy. For example, a user may characterize a particular selection of audio files by band name or composer. A file may be created for each band or composer. Such indexed filing of content allows for ease of search. Thus, when a user wants to listen to the Dave Matthews Band, the connector application 170 may immediately parse those files in the ‘Dave Matthews Band’ file folder and identify them to the user of mobile device 110 via content server 120. Other file structures are envisioned including ‘favorites’ or particular ‘genres’ of music.

Unstructured content 188 is that content that is not necessarily ordered or organized by the user but that exhibits other indicia or characteristics that allow for indexing. For example, audio files may be ordered by title, frequency of playback, composer, music group, genre, volume, encoded bit rate, file format and so forth as identified through metadata. This metadata may be generated by the source of the content or manually entered by a third-party including the user. To make unstructured content 188 searchable, index engine 175 searches all unstructured content 188 (and structured content 184 if so desired) in accordance with the search parameter identified by the user of mobile device 110 via content server 120. Various search algorithms as known in the art may be implemented to be as inclusive or exclusive as may be desired.

Network service 190 may be a content portal such as Yahoo!, YouTube, iTunes, or Rhapsody. The index engine 175 of the personal computer 160 may interact with the network service 190. For example, a user of mobile device 110 may interact with their personal computer 160 via connector application 170 and content server 120. The user may then use their personal computer 160 as a proxy to provide user name and password data to the network service 190 allowing for access to content therein. In some embodiments, however, the content server 120 may be able to directly interact with the network service 190 through direct provisioning of the aforementioned credentials. In such an embodiment, the network service 190 may include its own index engine to interact with content server 120. Network service 190 may also (or alternatively) have its own native search engine allowing for parsing of available content.

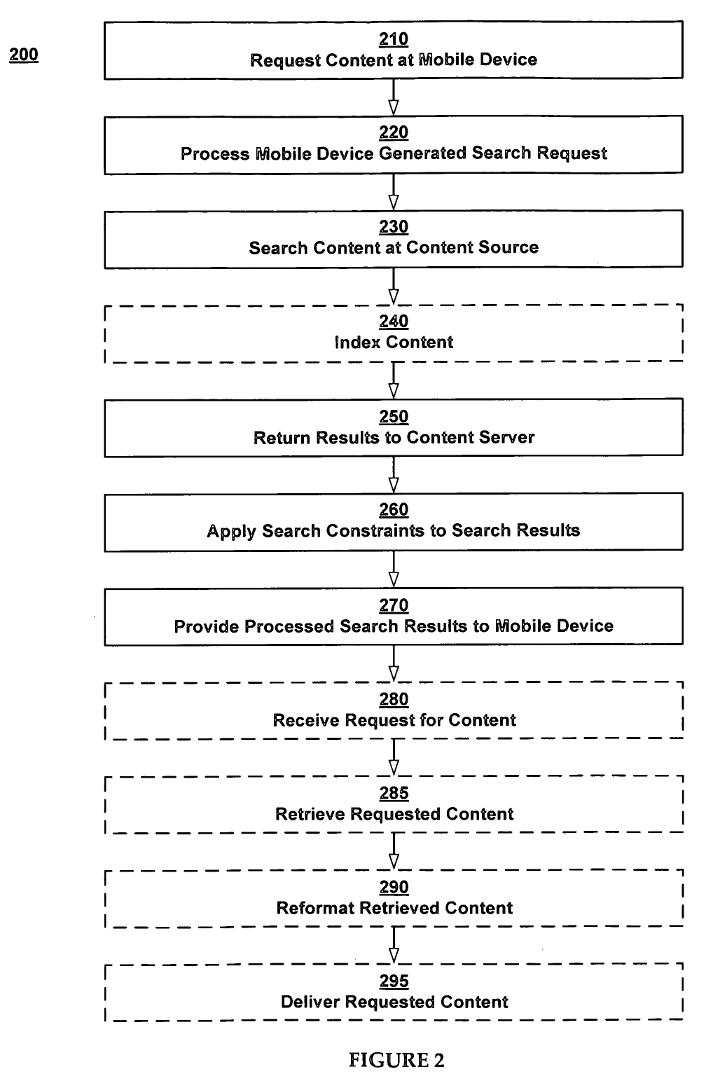

FIG. 2 depicts an exemplary method 200 for performing content searches initiated by a mobile device. As noted in the context of FIG. 1, all of the content available at a content source and that falls within a user generated search request may not be useful or accessible to the mobile device user. In order to provide useful search results (i.e., search results that correspond to content actually accessible to the user), the search results need to be processed to correspond to any number of search constraints. Identifying content that is or that would violate one of the aforementioned search constraints (i.e., user preferences, device capabilities, network service provider constraints) is not useful. Further, providing this content (and allowing a user to select the same for delivery) may result in operational difficulties at mobile device 110 (e.g., application failures) or incur unwanted costs on the user (e.g., penalties for exceeding network bandwidth allocations). This non-useful content is removed from the search results provided to the user of the mobile device 110.

In step 210, an initial search request for content is generated at the mobile device. A user may identify any number of search parameters including artist, album, song title, popularity, and genre. In step 220, the search request is processed at the content server. The content server may reformat the request such that it corresponds to the search format requirements of any number of content sources. The search request may, in some instances, preliminarily identify any number of search constraints as a further search parameter thereby making step 260 as described below unnecessary.

In step 230, a search takes place at the content source for content corresponding to the mobile device generated search request. The search for content may also take into account an additional search parameter (e.g., a search constraint) as may be introduced by the content server. In optional step 240, content may be indexed the content source. Indexing of content may be limited to unstructured content or may include all content at the source including structured content. The results of the search, which may use any search algorithm as known in the art, are returned to the content server in step 250.

In step 260, the search constraints are applied to the returned search results. As such, the initial data set returned from the content source or sources is reduced to a more specific set of data (i.e., responsive results that are filtered in light of the search constraint). As noted above, the content server may append the search constraint upon its receipt of the search request. In such an embodiment, step 260 need not be executed.

In step 270, the search results that are indicative of responsive search results and the search constraint are provided to the mobile device. In this fashion, only the content that corresponds to the wants of the requesting user as well as the limitations of a mobile device, network requirement, or user limitation will be displayed. As a result, the user need not search through various search results by trial-and-error as those results may concern unavailable, illegal, or illicit content.

Steps 280, 285, 290, and 295 are may be executed following the delivery of search results to the user in step 270. As step 280, the content server receives a user selection of desired content as identified in the results of step 270. In step 285, the content is retrieved from the appropriate content source, which may be a personal computer or network service. In step 290, the content may be reformatted by a reformatting engine as described in the context of FIG. 1. Reformatting may be necessary if the content, in its native format, does not comply with a search constraint but is otherwise available following a reformatting operation. In step 295, the content is delivered to the mobile device.

Additional steps may be implemented with respect to the method 200 of FIG. 2. For example, content, requests for content, or search requests may be re-routed through any number of proxy servers. Further, provisioning of credentials to allow for access to a personal computer or a network service, which may occur via personal computer may take place. Prioritization of search requests and content delivery may also take place as may various ancillary activities such as billing, look-up of search constraints, processing requests to reformat content and so forth.

The aforementioned method may be executed by a processor at a computing device. The computing device may execute this method through the processing of a computer program embodied in a computer-readable storage medium. The storage medium is inclusive of media such as a CD, memory, floppy disk, flash memory, hard drive, and so forth.

While the present invention has been described in connection with a series of preferred embodiments, these descriptions are not intended to limit the scope of the invention to the particular forms set forth herein. For example, any number of the functionalities described herein may be distributed to one or more computing devices or offloaded to or combined with other devices performing other primary functionalities. To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A system for searching content comprising:
a mobile device configured to generate a search request to be processed by a content server;
a content source including a database of content; and
a content server configured to receive search requests from the mobile device, the content server further configured to generate search requests to be processed by the content source, wherein a response to the search request corresponds to a search constraint.

2. The system of claim 1, wherein the search constraint includes a network service provider policy.

3. The system of claim 1, wherein the search constraint includes a mobile device capability.

4. The system of claim 1, wherein the content source is a network service including an index engine configured to parse content at the network service.

5. The system of claim 1, wherein the content source is a personal computer including an index engine configured to parse content in a database.

6. The system of claim 1, wherein the content server is further configured to reformat content from the content source such that content corresponds to a limitation of the search constraint.

7. The system of claim 1, further comprising a proxy configured to execute a premium service search.

8. The system of claim 1, further comprising a proxy configured to execute a geographically localized search.

9. The system of claim 1, further comprising a proxy configured to execute a dedicated search.

10. A method for searching for content comprising:
processing a mobile device generated request for content at a content server;
requesting a content source to identify content corresponding to the search request generated by the content server, wherein the mobile device generated search request corresponds to the content server generated search request;
receiving search results responsive to the content server generated search request at the content server;
identifying search results responsive to the content server generated search request that correspond to a search constraint; and
providing a sub-set of the search results responsive to the content server generated search request to the mobile, wherein the sub-set of the search results corresponds to both the mobile device generated request for content and the search constraint.

11. The method of claim 10, wherein the search constraint includes a network service provider policy.

12. The method of claim 10, wherein the search constraint includes mobile device capabilities.

13. The method of claim 10, wherein the identification of search results responsive to the content server generated search request occurs at a proxy.

14. The method of claim 10, further comprising indexing content at the content source to generate search results responsive to the content server generated search request.

15. The method of claim 14, wherein indexing content includes indexing of unstructured content.

16. The method of claim 14, wherein indexing content includes indexing of structured content.

17. A computer readable storage medium having thereon a program, the program being executable by a processor for performing a method for searching content, the method comprising:
processing a mobile device generated request for content at a content server;
requesting a content source to identify content corresponding to the search request generated by the content server, wherein the mobile device generated search request corresponds to the content server generated search request;
receiving search results responsive to the content server generated search request at the content server;
identifying search results responsive to the content server generated search request that correspond to a search constraint; and
providing a sub-set of the search results responsive to the content server generated search request to the mobile, wherein the sub-set of the search results corresponds to both the mobile device generated request for content and the search constraint.

18. The computer-readable storage medium of claim 17, wherein the search constraint includes a network service provider policy.

19. The computer-readable storage medium of claim 17, wherein the search constraint includes mobile device capabilities.
